(19) United States
(12) Patent Application Publication
(10) Pub. No.: US 2014/0186880 A1
(43) Pub. Date: Jul. 3, 2014

(54) SALMONELLA AND/OR E. COLI ENZYME TEST AND/OR LIQUID DROP TEST FOR BIOLOGICAL SUBSTANCES, ON NON-HUMAN SAMPLES

(71) Applicant: William Lowenkamp, JR., Hazlehurst, MS (US)

(72) Inventor: William Lowenkamp, JR., Hazlehurst, MS (US)

(21) Appl. No.: 13/729,938

(22) Filed: Dec. 28, 2012

(51) Int. Cl. G01N 21/78

(52) U.S. Cl. CPC G01N 21/78
USPC 435/38; 435/34

(57) ABSTRACT

A test kit and test apparatus are provided for the detection of enzymes excreted by broken or ruptured bacteria cells in various environments, such as in the field, soil extracts, produce washing, slaughter houses, food preparation area's and other related or non-related areas where a quick test or rapid test is needed to obtain qualitative results. The method utilizes various components which allow for the collection of a sample from suspected contaminated areas. One method is to collect a sample from a pond or other water source possibly contaminated and by using a clean lab sample tube or clean plastic bag, a field hand mixer, a buffer, a pipette and a test strip with a reagent pad.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to a test kit and test apparatus including test strips, for detecting Salmonella and/or E. Coli using an enzyme test and/or a liquid drop test for biological substances, on non-human samples.

### BACKGROUND OF THE INVENTION

There is no test available for producers of food products to perform a simple test in house or in the field to be able to ascertain that products are free of biological contamination. This causes major problems for companies that could employ this simple test and quarantine suspected product that may be contaminated without shutting down a complete operation. The current 24 hour test is too costly for a company to shut down until an outside laboratory furnishes results when, in fact, the company could perform the 24 hour test in house on quarantined product.

Laboratory drug testing procedures are known using gas chromatographs, laboratory reagents and equipment, and other methods. However, field testing and in-home testing remains difficult and uses cumbersome equipment which may involve mixing of liquids, complex steps and procedures, and/or requires expensive equipment.

It is a problem in the art to perform quick and easy drug testing for Salmonella and/or E. Coli with immediate results, and particularly for field testing for Salmonella and/or E. Coli.

Also, it is a problem in the art to perform quick and easy testing for Salmonella and/or E. Coli with immediate results, and particularly for field testing for use by individuals concerned with food safety such as grocers, restaurant managers and workers, food warehouse workers, and home users, among others.

Several prior patents are known in this field. These include: U.S. Pat. No. 4,689,295 Taber et al. Aug. 25, 1997 (Salmonella); U.S. Pat. No. 6,368,817 B1 Perry et al. Apr. 9, 2002 (Salmonella); U.S. Pat. No. 6,136,554 Bochner Oct. 24, 2000 (Salmonella and E. Coli); U.S. Pat. No. 6,063,590 Brenner et al. May 16, 2000 (Coliforms and E. Coli); and U.S. Pat. No. 6,620,585 Zyskind Sep. 16, 2003 ((Ectoenzymes and Secreted Enzymes).

### SUMMARY OF THE INVENTION

From the foregoing, it is seen that it is a problem in the art to provide a test kit and test apparatus meeting the above requirements. According to the present invention, a test kit and test apparatus is provided which meets the aforementioned requirements and needs in the prior art. Specifically, the device according to the present invention provides a test kit and test apparatus having test strips.

This is a preliminary test taking less than 1 hour to produce a result. The invention can be used in the field, in the lab, or workplace. The methodology and technique can be used for identifying pathogenic bacteria such as Salmonella and E. Coli. There are other pathogenic bacteria's that can be developed for this methodology. The identification of the bacteria strain turns the pad from a light blue to a dark blue. The Salmonella types or subtypes are: Typhimurium, Heidelberg and Newport. The e. Coli is 0157:H7. The substrates used and the formulation are proprietary, but any one having skill in the bacterial testing arts can provide a suitable substrate, and all such variations are contemplated as being within the scope of the present invention. Sigma Aldrich is the source for the positive controls to insure the formulation is consistent.

A method and preliminary test for the detection of enzymes excreted by broken or ruptured bacteria cells in various environments, such as in the field, soil extracts, produce washing, slaughter houses, food preparation area's and other related or non-related areas where a quick test or rapid test is needed to obtain qualitative results.

The method utilizes various components which allow for the collection of a sample from suspected contaminated areas.

One method is to collect a sample from a pond or other water source possibly contaminated and by using a clean lab sample tube or clean plastic bag, a field hand mixer, a buffer, a pipette and a test strip with a reagent pad. The water becomes the elute to test, add 3 to 5 drops of buffer reagent, and then mixed with the hand mixer to break the bacteria cells. The strip reagent pad can be dipped into the elute for 2 seconds and swirled around or the pipette can be used to add 2 to 3 drops maximum to the pad on the test strip.

Another method is to collect a solid sample and/or liquid sample, place it in a sealable plastic bag, add 50 ml to 100 ml maximum to the bag, add 3 to 5 drops of buffer reagent, seal the bag, manipulate the sample with the fingers to break open bacteria cells present and then perform the test by using the pipette and placing 2 to 3 drops maximum of the elute on the test strip pad. If the elute is too dark, lighten it by adding distilled water to the sample. Depending on the level of enzymes released by ruptured or broken cells, this will determine the time element to observe a positive or negative reaction.

The methodology uses readily available materials. The buffer reagent used can be a lysis reagent or other reagent then can assist in cell softening.

And, the device of the present invention is lightweight and easy to use.

Other objects and advantages of the present invention will be more readily apparent from the following detailed description when read in conjunction with the accompanying drawings.

### BRIEF DESCRIPTION OF THE DRAWINGS

FIG. 1 is an illustration of a test on tainted cucumber from a store produce department.

FIG. 2 is a depiction of test equipment and results of a test for Salmonella Tpi, showing a positive result.

FIG. 3 is a perspective view of items and equipment used to conduct tests on tainted olives from a store shelf, together with the bottle of olives to be tested.

FIG. 4 is a view of four test strips showing a left pair showing a negative and positive Salmonella test strip, and a right pair showing a negative and positive e. Coli test strip.

FIG. 5 is a view of four test strips showing two single strips on the left for Salmonella and E. Coli respectively, and two cards on the right side, wherein each card has one test strip for Salmonella and one test strip for E. Coli, and wherein the left card shows positive results and the right card shows negative results for both strips.

FIG. 6 is a view showing parts used in a test involving a single test strip, including a sealed foil pouch, a test strip, a pipette, and a desiccant packet.

FIG. 7 is a view showing a container and parts used in a test kit, including a plurality of test strips, a tube with a lid, and a packet of desiccant

FIG. 8 illustrates a sample preparation kit for non-liquid substances, including a sealable bag, a pipette, and a buffer lysis reagent.

FIG. 9 shows a front view of a battery operated hand mixer, used to break bacteria cells to release enzymes

### DETAILED DESCRIPTION OF THE INVENTION

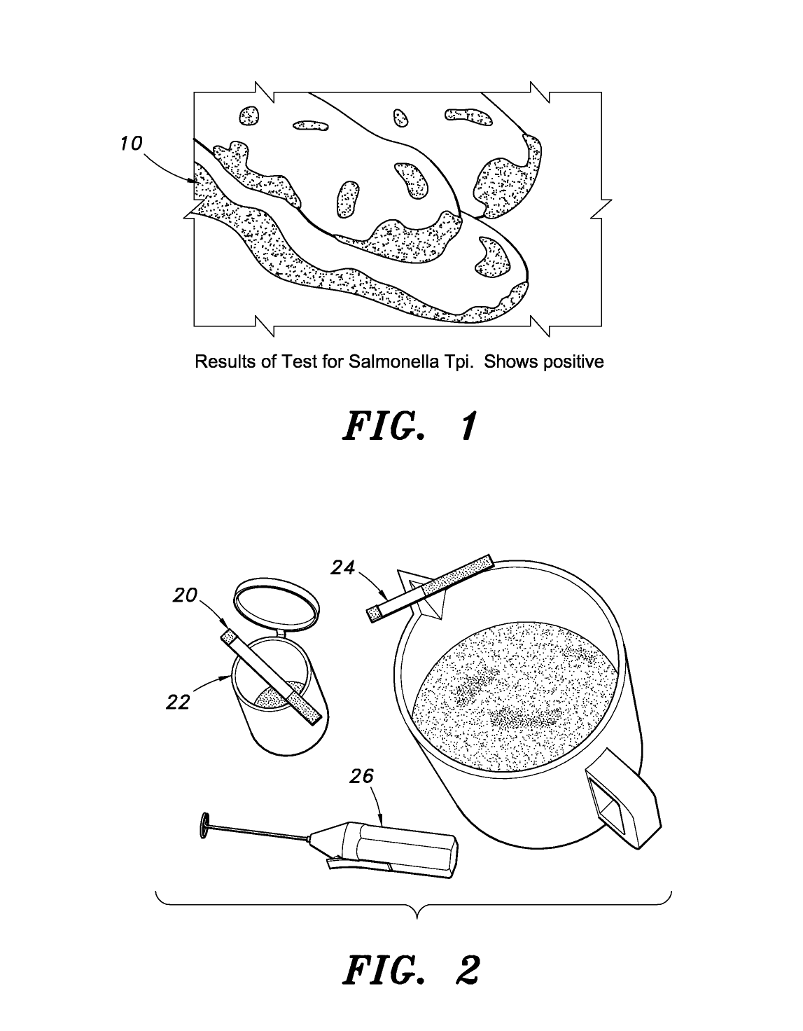

FIGS. 1-9 show a examples of testing and test kits, to detect enzymes released by bacteria cells, and in particular to detect Salmonella and E. Coli. These FIGS. 1-9 are discussed further hereunder.

FIG. 1 is an illustration of a test on tainted cucumber 10 from a store produce department.

FIG. 2 is a depiction of test equipment and results of a test for Salmonella Tpi, showing a positive result. Here, a test strip 24 reads as positive (the tip at the left end has changed to the color blue), and a hand mixer 26 is shown along with another test strip 20 and a container 22.

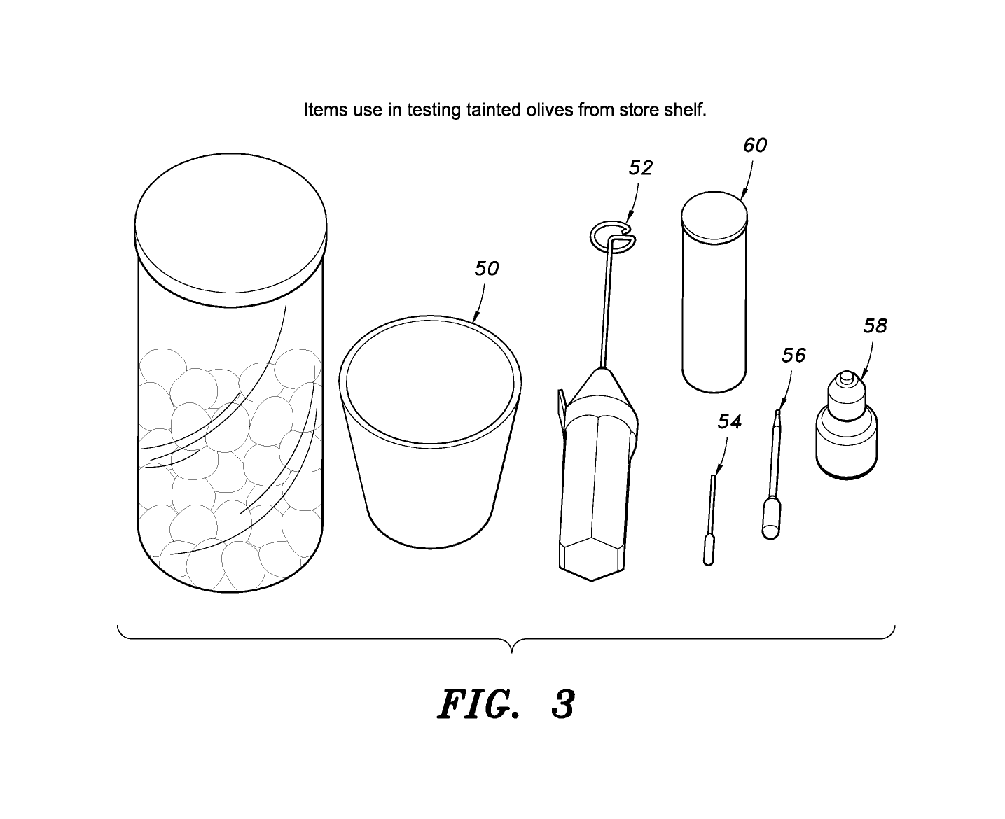

FIG. 3 is a perspective view of items and equipment used to conduct tests on tainted olives from a store shelf, together with the bottle of olives to be tested. A container 60 is shown, and is intended to contain a plurality of test strips for detecting Salmonella. Also shown in this kit are the following items: a cup 50, a hand mixer 52, a first pipette 54, and a second pipette 56, as well as a bottle 58 of buffer reagent or lysis reagent.

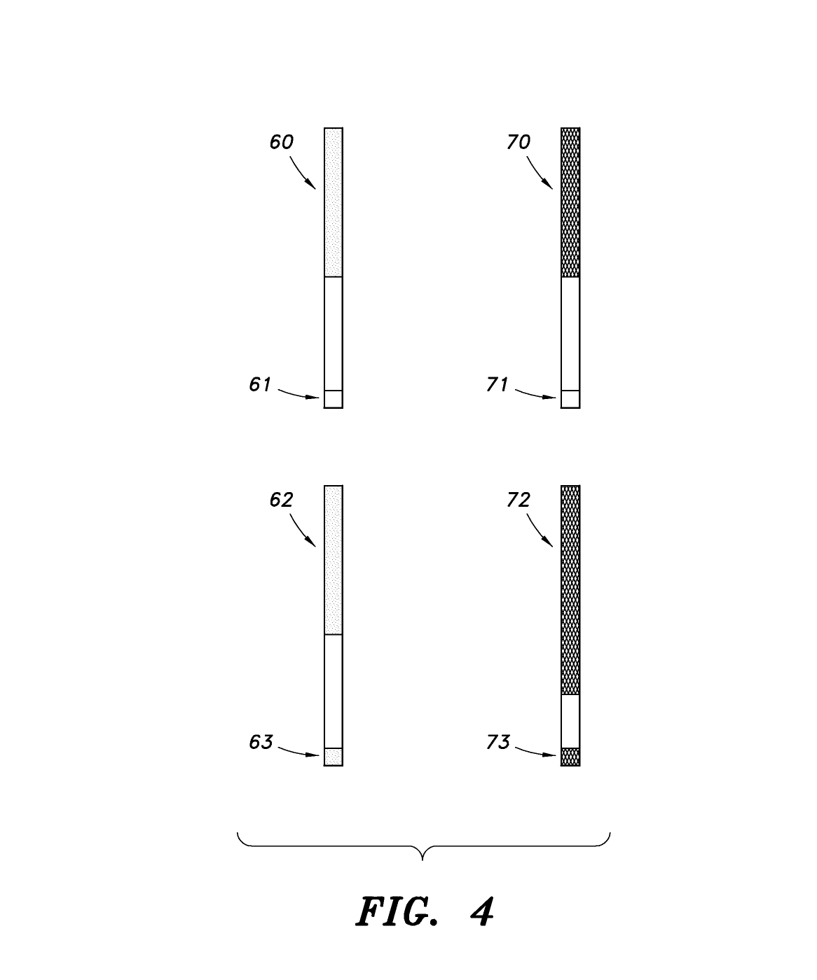

FIG. 4 is a view of four test strips 60, 62, 70, and 72 showing a left pair 60 and 62 respectively showing a negative and positive Salmonella test strip result. Specifically, for the test strip 60 the tip 61 is white, indicating a negative result, while for the test strip 62 the tip 63 is dark (blue) indicating a positive result. The pair of test strips 70 and 72 on the right pair show, respectively, a negative and positive e. Coli test strip result.

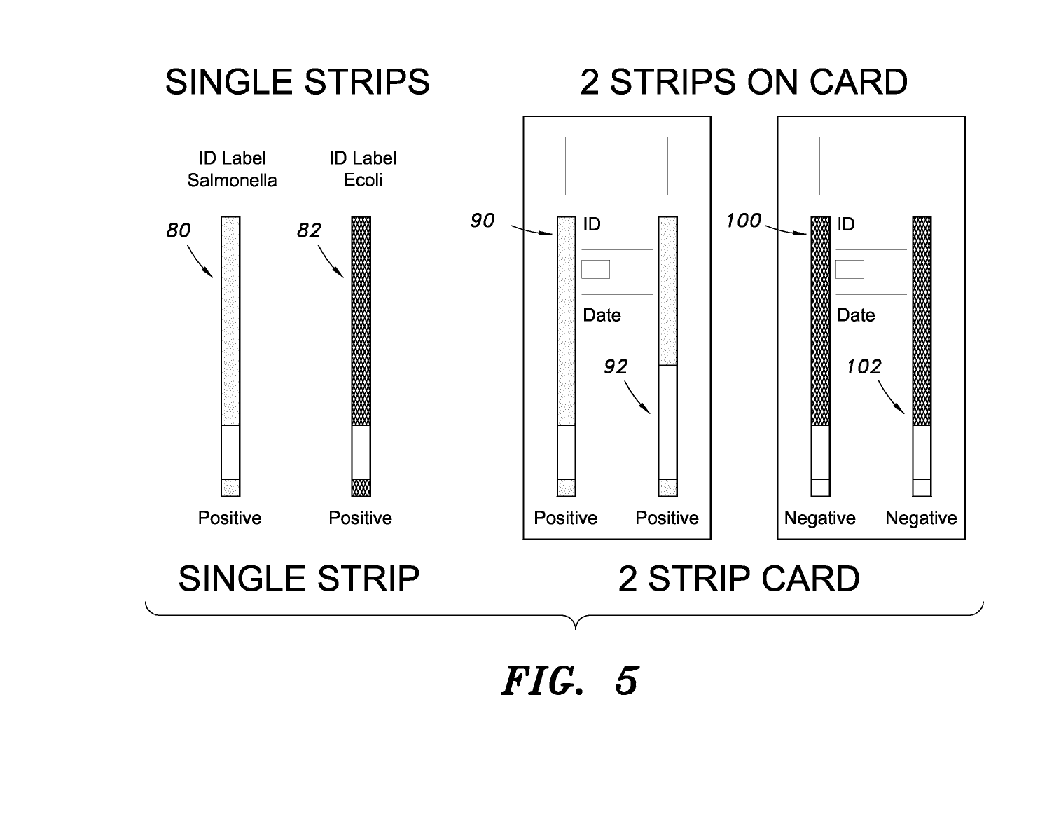

FIG. 5 is a view of four test strips 80, 82, and on one card two test strips 90, and 92. Another test card has two test strips 100 and 102. The strips 80 and 82 indicate positive results for Salmonella and E. Coli respectively. The two test strips 90 and 92 mounted on a single card can be for Salmonella and E. Coli, respectively, and are shown as having test positive results (by the dark lowermost end). The two test strips 100 and 102 are also mounted on a single card, and are shown as having negative results. The two test strips 100 and 102 can be for Salmonella and E. Coli respectively.

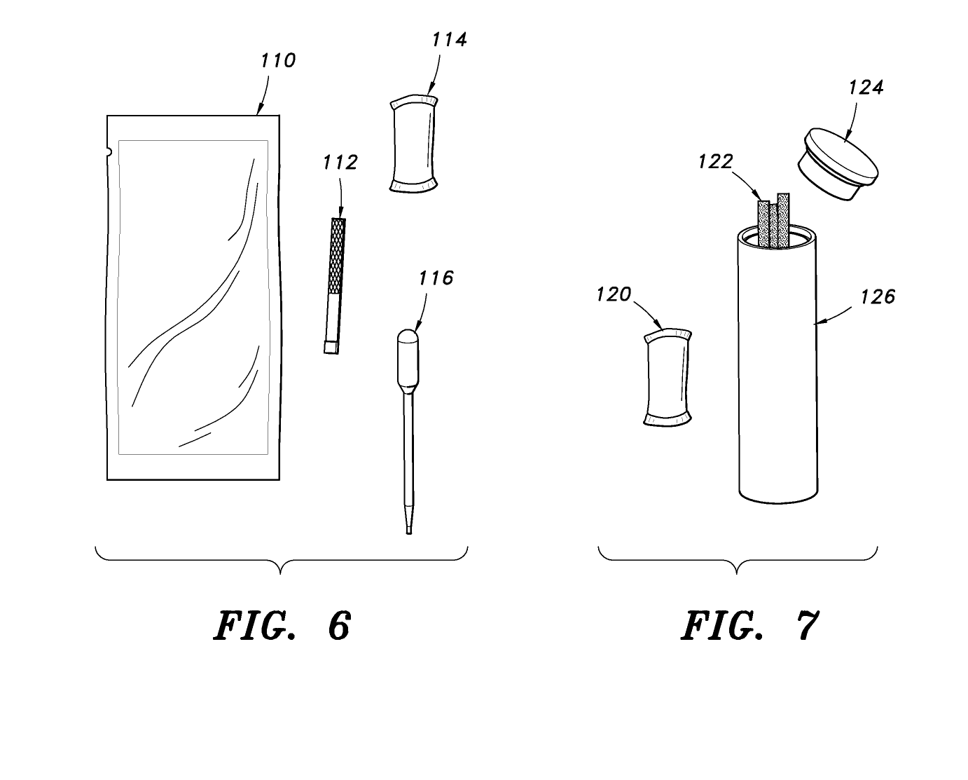

FIG. 6 is a view showing parts used in a test involving a single test strip, including a sealed foil pouch 110, a test strip 112, a pipette 116, and a desiccant packet 114.

FIG. 7 is a view showing a container and parts used in a test kit, including a plurality of test strips 122, a tube 126 with a lid 124, and a packet of desiccant 120. The tube is preferably sized to contain 25 to 50 test strips. In this figure, the test strips are for E. Coli, and it is contemplated to use test strips for Salmonella with this type of container as well.

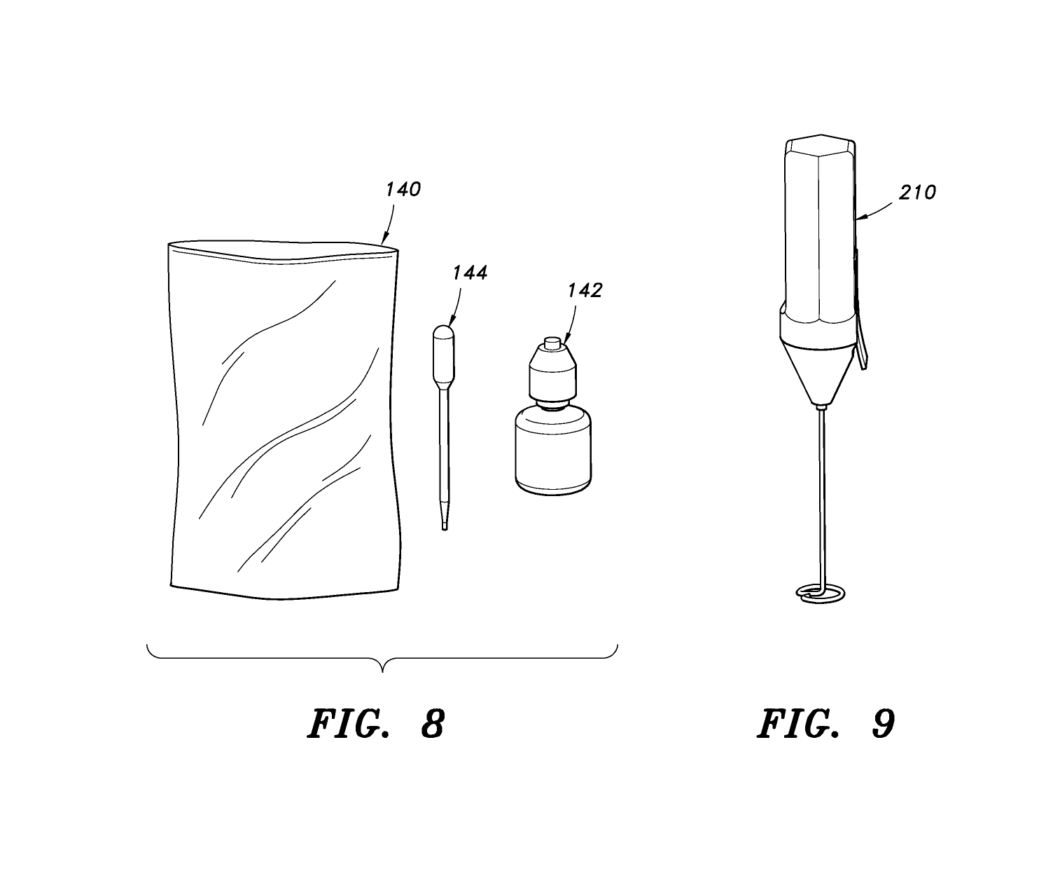

FIG. 8 illustrates a sample preparation kit for non-liquid substances, including a sealable bag 140, a pipette 144, and a buffer lysis reagent 142. The bag 140 is for the sample to be tested, and the pipette 144 has a volume of 0.3 to 0.5 ml.

FIG. 9 shows a front view of a battery operated hand mixer 210, used to break bacteria cells to release enzymes. It is contemplated that other types of hand mixers can be used, and/or other tools or devices, to aid in breaking of the cell walls to release the enzymes.

Multiple test strips, e.g. test strips 122, can be packaged in the foil pouch 110. For instance, twelve strips 122 or twenty-four strips 122 can be packaged in the foil pouch 110,

Two tables that follow respectively show (a) a methodology sheet hard, semi-hard or soft samples, and (b) a methodology sheet for liquid samples or liquid from solids.

To clarify how these tests work:

1. A novel feature of the present invention, which has been unavailable in the prior art, is providing an apparatus and method to provide real time testing to allow for the visual observance of leached out live enzymes from e. Coli or Salmonella bacteria.

2. This test methodology allows for the testing of production such as meats, produce, counter tops, slicers, etc., to determine the presence of e. Coli or Salmonella live enzymes by breaking the cells to release the toxic enzymes.

3. This test methodology can be used in the field, at washing stations and in many areas that could harbor harmful bacteria.

Confirmation testing can be accomplished using M-Coli Blue plates for e. Coli and MSG or SOY plates and others for Salmonella.

This overcomes a problem with prior art lab testing methods: the testing methodology of the present invention is meant to be used with the real bacteria and the live enzymes. By contrast, performing a test in a lab with lab grown bacteria will not succeed, since the results will be virtually 100% negative because the growth mediums used kill the toxic enzymes.

As examples: The present invention uses the strips on a peanut butter specimen with positive results. Also, in testing, the strips of the present invention have been successfully able to test tainted produce found in stores and yield positive results.

Discussion of Testing

A method and preliminary test is shown and described herein for the detection of enzymes excreted by broken or ruptured bacteria cells in various environments, such as in the field, soil extracts, produce washing, slaughter houses, food preparation area's and other related or non-related areas where a quick test or rapid test is needed to obtain qualitative results.

The method utilizes various components which allow for the collection of a sample from suspected contaminated areas.

One method is to collect a sample from a pond or other water source possibly contaminated and by using a clean lab sample tube or clean plastic bag, a field hand mixer, a buffer, a pipette and a test strip with a reagent pad. The water becomes the elute to test, add 3 to 5 drops of buffer reagent, and then mixed with the hand mixer to break the bacteria cells. The strip reagent pad can be dipped into the elute for 2 seconds and swirled around or the pipette can be used to add 2 to 3 drops maximum to the pad on the test strip.

Another method is to collect a solid sample and/or liquid sample, place it in a sealable plastic bag, add 50 ml to 100 ml maximum to the bag, add 3 to 5 drops of buffer reagent, seal the bag, manipulate the sample with the fingers to break open bacteria cells present and then perform the test by using the pipette and placing 2 to 3 drops maximum of the elute on the test strip pad. If the elute is too dark, lighten it by adding distilled water to the sample.

Depending on the level of enzymes released by ruptured or broken cells this will determine the time element to observe a positive or negative reaction.

The methodology uses readily available materials. The buffer reagent used can be a lysis reagent or other reagent then can assist in cell softening.

Summary of Steps taken for using the Salmonella and/or E. Coli Test strips
1. Do NOT clean suspected surfaces to be tested.
2. Do NOT dilute samples more than recommended.

Materials: (Read Instruction Sheet thoroughly)
a. Test Strips with Test Pad attached
b. Bottle of Buffer Reagent or Lysis Reagent (dropper bottle)
c. Pipette
d. Desiccant
e. Sealable Poly Bag for Processing Sample
   (Mixer is only supplied if requested.)
1. Open the test strip or cassette (card) package and remove.
2. Lay the strip with pad up on a clean surface.
3. Take the pipette and draw an 0.3 to 0.5 ml sample from the elute.
4. Place 2 to 3 drops maximum on the test pad.
5. Allow to stand for 15 minutes to 55 minutes.
6. Read the Color Change (Blue for Positive or White for Negative.)
7. Results should be within 15 minutes for Salmonella and 55 minutes for E. Coli.

Results Desired: To determine that the strips will work with un-prepared foods, vegetables and produce. Also, to test the water sample taken from an infected pond and from one stream with stagnant water flow.

SAMPLE PREPARATION for Pond Water, Slurries, any place where there is stagnant water, liquids and the infestation of bacteria is suspected to be present:
1. Take 100 ml Sample from source of suspected biological activity. Save the other 50 ml for a re-test if necessary or other testing that may be desired.
2. Use 50 ml of the sample for the test sample.
3. Add Lysis Reagent at 5 ml to a 50 ml test sample, mix well, allow to stand for 10 to 15 minutes and mix again.
4. Method of Strip Use.
   a. Insert Pad End of Strip into the test sample for 30 seconds minimum but not longer than 45 seconds. Remove the strip and place on a non-absorbent surface, such as wax paper, plastic sheet etc. Wait for 10 minutes and observe for a color change (there might be a non-visible color change which would require a black light to recognize) after 15 minutes the pad will be completely saturated and will begin to dry. After 30 minutes the pad will be drying out and a response will begin to appear up until 50 to 60 minutes. When the pad dries, if there is any bacteria present it will turn blue (from a very light blue to a dark blue depending upon the amount of CFU's (Colony Forming Units) in the sample.
   b. Another simple method that can be used is as follows: Lay the strip with Pad up on a non-absorbent surface. Take a Straw Dispenser (0.03 or 0.05 ml) or a 0.05 ml Pipette and fill with the test sample. Place a drop on the pad and allow to be absorbed by the pad, usually 5 minutes, place another drop on the pad to allow for complete saturation. The time to show a negative or positive reaction is about the same as for dipping the strip.

SAMPLE PREPARATION for general surfaces such as food preparation areas, meat cutters, anywhere where there is a chance for food to become cross-contaminated and/or stuck to areas caused by poor cleaning and then allowed to become active biologically:
1. Spray the suspected area with distilled water and scrap together into a pool.
2. Take a pipette and siphon off at least 1 to 5 ml of sample and place in a sample tube.
3. Add 0.5 ml reagent to the sample, close cap and shake for 1 minute vigorously.
4. Take the test strip and insert into the tube (you might have to tip the tube to obtain complete coverage of the pad) for no more than 30 seconds.
5. Remove the strip and place on a nonabsorbent surface (piece of plastic, wax paper etc.) and allow to react for a period of time from 15 minutes to 55 minutes.

SAMPLE PREPARATION for prepared foods.
1. Mix the prepared food together is a sample tube or small plastic cup/dish.
2. Add distilled water and mix. Pour off the elute (about 5 to 10 ml) into a sample tube and add 1 ml of reagent.
3. Immerse the pad end of the strip into the tube for 30 seconds.
4. Remove the strip and place on a nonabsorbent surface (piece of plastic, wax paper etc.) and allow to react for a period of time from 15 minutes to 55 minutes.

Note: These strips are for a presence/absence test only to identify that a laboratory confirmatory test should be done to confirm positive readings. If the Colony Forming Units are above 10 CFU's/ml of sample there should be a visible result within 5 to 20 minutes and a complete result within 60 minutes or when the pad fully absorbs the sample and becomes dry. It is noted that the recommended time to dip a test strip into a test sample can be 15-30 seconds, but longer times (30 seconds to 45 seconds) will also work.

Tables

The two tables mentioned hereinabove follow as the next two pages.

Methodology for Testing with MCC Salmonella or MCC e. Coli Screening Test Strips (Active Enzyme Testing) This is a preliminary screening test for the live active enzymes. Note: This is a Screening Test also known as a Preliminary Test for e. Coli (0157:117) and Salmonella (s.Tphi) Strips.

Sample Method for Solid Hard, semi-hard or soft Samples
(This includes, meats, fat, tissue, skins, fruits, vegetables, seeds, feeds, etc.)

| Step | Method 1 BASIC Procedure (modifiable for test volume) |
|---|---|
| 1 | Sample - Take 3 to 6 ounces |
| | Water - Place in 100 ml distilled water or pour in 100 ml distilled water into a clean container. Agitate |
| | by shaking and allow to stand for 3 to 5 minutes. |
| 2 | Pour off elute (liquid) into a clean cup (You must clarify the elute if you cannot visually see through it.) |
| | The elute must not be so dark as to impede the color change to the pad if live enzymes are present. |
| 3 | Add 5 drops Buffer for 80 to 100 ml of sample Pre-pared Foods |
| | Add 3 drops of Buffer for 50 to 80 ml of sample |
| | Add 2 drops of Buffer for 10 to 50 ml of sample |
| | Add 1 drop of Buffer for less than 10 ml of sample |
| 4 | Blend/mix |
| | 3000 rpm for 2 to 3 seconds (5 seconds maximum) or Manipulate with fingers in a zip lock bag for 30 |
| | to 60 seconds max. |
| 5 | Allow sample test elute to stand for 5 minutes before testing. |
| 6 | Place Salmonella or e. Coli strip on a non-absorbent surface. |
| | Place 2 drops maximum of elute on the test pad. Or insert strip into elute for 10 seconds. |
| | (Do not allow the elute to run off the pad.) |
| Result | After 30 minutes you should see a color change begin to appear and the result can take up to 50 minutes |
| 30 min. | depending on the level and strength of the DNA (enzymes) released by breaking the bacteria cells. |
| Result | Pad should absorb liquid and be almost dry. Presence of live bacteria enzyme should be noticeable |
| 60 min. | after 15 to 50 minutes and a definite pronounced visual indication at 60 minutes. e. Coli = 40 to 50 |
| Maximum | minutes Salmonella = 15 to 30 minutes |

Note:
Do not blend the sample and the water together. Blend only the elute poured off from the sample.

This is not a Confirmatory Test and does not need to be certified under AOAC International, FDA or USDA at this time. This is a Screening or Preliminary Test for the Presence of live enzymes or DNA from Salmonella and e. Coli (0157:117)

Information on running a plate test for confirmation in your lab can be obtained from Sigma-Aldrich Chemicals, and HACH Corporation.

Method for Liquid Samples or Liquid from Solid Samples
(This includes washed liquids from any sample material, slurries, ponds, streams, wells, water supply,
standing ground water, water supply to livestock, live animal body parts, pasture land, etc.)

| Step | Method 1 (modifiable for test volume) |
|---|---|
| 1 | Sample - Take 100 ml sample minimum from a specific location using a clean cup or sample tube. |
| 2 | (You must clarify the elute if you cannot visually see through it.) The elute must not be so dark as to |
| | impede the color change to the pad if live enzymes are present. |
| 3 | Add 5 drops Buffer for 80 to 100 ml of sample Pre-pared Foods |
| | Add 3 drops of Buffer for 50 to 80 ml of sample |
| | Add 2 drops of Buffer for 10 to 50 ml of sample |
| | Add 1 drop of Buffer for less than 10 ml of sample |
| 4 | Blend/mix |
| | 3000 rpm for 2 to 3 seconds 5 seconds maximum) or Manipulate with fingers in a zip lock bag for 30 |
| | to 60 seconds max. |
| 5 | Allow sample test elute to stand for 5 minutes before testing. |
| 6 | Place Salmonella or e. coli strip on a non-absorbent surface. |
| | Place 2 drops maximum of elute on the test pad. Or insert strip into elute for 10 seconds. |
| | (Do not allow the elute to run off the pad.) |
| Result | After 30 minutes you should see a color change begin to appear and the result can take up to 50 |
| 30 min. | minutes depending on the level and strength of the DNA (enzymes) released by breaking the bacteria |
| | cells. |
| Result | Pad should absorb liquid and be almost dry. Presence of live bacteria enzyme should be noticeable |
| 60 min. | after 15 to 50 minutes and a definite pronounced visual indication at 60 minutes. e. Coli = 40 to 50 |
| Maximum | minutes Salmonella = 15 to 30 minutes |

Note:
This test has been employed by produce growers and chicken processors in the US and found to be an acceptable screening test or preliminary test of product.

This test is for the Live Enzyme leached out of a broken or ruptured bacteria cell.

Information on running a plate test for confirmation can be obtained from Sigma-Aldrich Chemicals, and HACH Corporation.

The invention being thus described, it will be evident that the same may be varied in many ways by a routineer in the applicable arts. Such variations are not to be regarded as a departure from the spirit and scope of the invention and all such modifications are intended to be included within the scope of the claims.

1. A testing method for using a testing kit for testing solid, hard, semi-hard, or soft samples for Salmonella or E. Coli, comprising the steps of:
providing a testing kit;
placing a sample in distilled water,
agitating the sample,
pouring off elute liquid,
adding buffer,
blending the sample,
allowing the sample to stand,
placing a test strip for at least one of Salmonella and E. Coli on non-absorbent surface,
placing elute on each test strip for approximately 10 seconds,
waiting for a period of time sufficient for results to appear for the test strip being used, and
observing whether a visual indication appears which shows a positive test result.

2. A testing method and kit for testing liquid samples, or liquid from solid samples, comprising the steps of:
take 100 ml sample from a specific location, add buffer, blend/mix the sample using a hand mixer, allow the sample to stand, place a test strip for Salmonella and/or E. Coli on non-absorbent surface, place two drops of elute on each test strip or alternatively insert test strip into elute for 10 seconds, wait for a period of time ranging from 15 minutes to 60 minutes depending on specific test strip type being used, and observing whether a visual indication appears which shows a positive test result.
